(19) United States
(12) Patent Application Publication
(10) Pub. No.: US 2009/0320243 A1
(43) Pub. Date: Dec. 31, 2009

(54) HINGE ASSEMBLY

(75) Inventors: JIN-XIN WANG, Shenzhen City (CN); XIAO-BO LI, Shenzhen City (CN); LIAN-CHENG HUANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/261,230

(22) Filed: Oct. 30, 2008

(30) Foreign Application Priority Data
Jun. 27, 2008 (CN) 200810302382.8

(51) Int. Cl. E05F 1/08

(52) U.S. Cl. 16/303

(57) ABSTRACT

An exemplary hinge assembly includes a rotatable shaft, a rotatable stand, a fixed stand, a restricting member, a cam, and a fastening member. The rotatable stand and the restricting member are non-rotatably connected to the rotatable shaft. The fixed stand and the cam are rotatably connected to the rotatable shaft. The cam is fixed to the fixed stand. The restricting member has a first restricting portion, the cam having a second restricting portion, the first restricting portion and the second restricting portion cooperatively define a rotating angle range between the rotatable stand and the fixed stand.

### BACKGROUND

1. Technical Field

The present disclosure relates generally to hinge assemblies and, more particularly, to a hinge assembly having a restricting unit for defining a rotating angle between a rotatable stand and a fixed stand.

2. Description of the Related Art

An electronic device such as a mobile phone, a notebook computer, or a personal digital assistant (PDA) generally has a main body and a cover with a display and a camera lens pivotally mounted on the main body via a hinge.

Referring to FIG. 5, a typical hinge 10 includes a shaft 11, a rotatable stand 12, a fixed stand 13, a restricting member 14, a cam 15, a cam follower 16, a plurality of spring washers 17, and a nut 18. A cross-section of the shaft 11 perpendicular to an axis of the shaft 11 is double-D shaped. A flange 111 is formed on a proximal end of the shaft 11, and a threaded portion 112 is formed on a distal end of the shaft 11. The rotatable stand 12 defines a pivot hole 121 for receiving the distal end of the shaft 11. A limiting protrusion 122 is formed on the rotatable stand 12 adjacent to the pivot hole 121. The rotatable stand 12 also defines a fixing hole 123 adjacent to the pivot hole 121. The fixed stand 13 defines a through hole 131 for receiving the proximal end of the shaft 11. The restricting member 14 defines an assembling hole 141 in a center portion of the restricting member 14. The restricting member 14 defines a limiting groove 142 in an edge portion of the restricting member 14. The cam 15 defines a cam hole 151 for receiving the distal end of the shaft 11. A fixing pole 152 extends from the cam 15. Two protrusions (not shown) opposite to each other are formed on a side surface of the cam 15 adjacent to the cam hole 151. A center of the cam follower 16 defines a pivot hole 161 for receiving the distal end of the shaft 11. The cam follower 16 defines two cutouts 162 on the cam follower 16 surrounding the pivot hole 161. The cutouts 162 are configured for engaging with the protrusions of the cam 15. The through hole 131 of the fixed stand 13, the cam hole 151 of the cam 15, and the pivot hole 161 of the cam follower 16 are non-circular holes corresponding to the shape of the cross-section of the shaft 11. The restricting member 14, the cam 15, and the cam follower 16 are generally made of a metal via powder metallurgy technique, to get a high rigidity and durability. The rotatable stand 12 and the fixed stand 13 are generally made of an alloy with a low rigidity, to reduce the manufacturing cost of the hinge 10.

In assembling the hinge 10, the threaded portion 112 of the shaft 11 extends through the assembling hole 141 of the restricting member 14, the pivot hole 121 of the rotatable stand 12, the cam hole 151 of the cam 15, the pivot hole 161 of the cam follower 16, the spring washers 17, and finally engages with the nut 18. The fixed stand 13 is fixed to the shaft 11 and touches the flange 111. The fixing pole 152 is inserted into the fixing hole 123 of the rotatable stand 12. The fixed stand 13, the restricting member 14, the cam follower 16 is non-rotatably connected to the shaft 11.

In use, the fixed stand 13 is rotated relative to the rotatable stand 12, and drives the shaft 11 to rotate, thus driving the restricting member 14 and the cam follower 16 to rotate. The limiting protrusion 122 of the rotatable stand 12 slides in the limiting groove 142 of the restricting member 14, in order to define a largest rotating angle between the rotatable stand 12 and the fixed stand 13.

However, since the restricting member 14 has a higher rigidity then the rotatable stand 12, the limiting protrusion 122 integrally formed on the rotatable stand 12 wears down after many cycles of the restricting member 14 rubbing against the limiting protrusion 122. Therefore, the largest rotatable angle between the rotatable stand 12 and the fixed stand 13 changes resulting in a short service life. In addition, if the rotatable stand 12 is made more durable to increase the service life of the hinge 10, a manufacturing cost of the hinge 10 will be increased.

Therefore, a hinge assembly to solve the aforementioned problems is desired.

### SUMMARY

An exemplary hinge assembly includes a rotatable shaft, a rotatable stand, a fixed stand, a cam, a restricting member, and a fastening member. The rotatable stand and the restricting member are non-rotatably connected to the rotatable shaft. The fixed stand and the cam are rotatably connected to the rotatable shaft. The cam is fixed to the fixed stand. The cam defines a restricting groove. The restricting member has a first restricting portion, the cam has a second restricting portion, the first restricting portion and the second restricting portion cooperatively define a rotating angle range between the rotatable stand and the fixed stand.

Other advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present hinge assembly. Moreover, in the drawings, like reference numerals designate corresponding parts throughout the several views.

FIG. 1 is an assembled, isometric view of an embodiment of a hinge assembly, the hinge assembly including a rotatable shaft, a rotatable stand, a fixed stand, a restricting member, a cam, a cam follower, a plurality of spring washers, two friction members, two washers, and a fastening member.

FIG. 2 is an exploded, isometric view of the hinge assembly in FIG. 1.

FIG. 3 is an exploded, isometric view of the hinge assembly in FIG. 1, but viewed from another aspect.

FIG. 4 is an assembled, isometric view of the hinge assembly of FIG. 1, with the rotatable stand rotating relative to the fixed stand.

FIG. 5 is an exploded, isometric view of a typical hinge assembly.

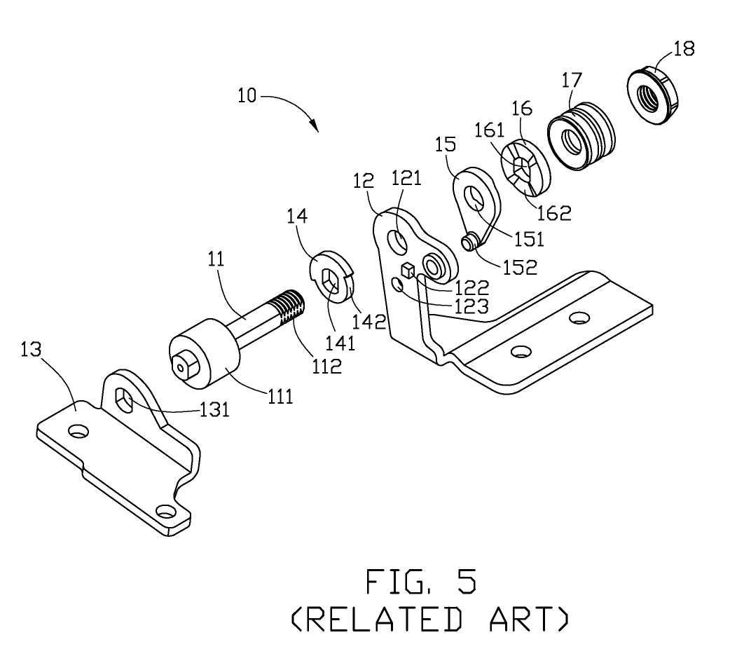

### DETAILED DESCRIPTION OF THE EMBODIMENTS

References will now be made to the drawings to describe embodiments of the present hinge assembly, in detail.

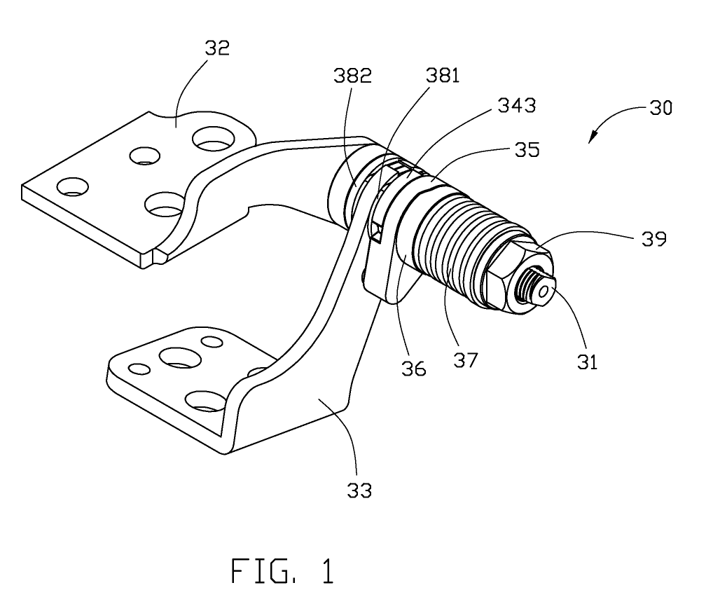

Referring to FIG. 1, an embodiment of a hinge assembly 30 includes a rotatable shaft 31, a rotatable stand 32, a fixed stand 33, a restricting member 34, a cam 35, a cam follower 36, a plurality of spring washers 37, two friction members 381, two washers 382, and a fastening member 39.

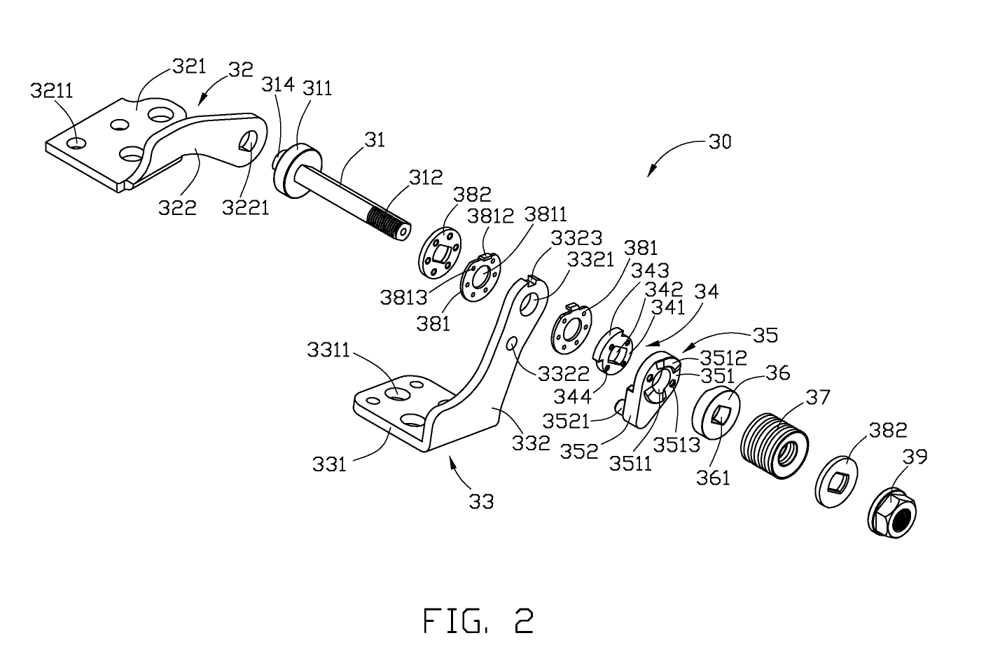

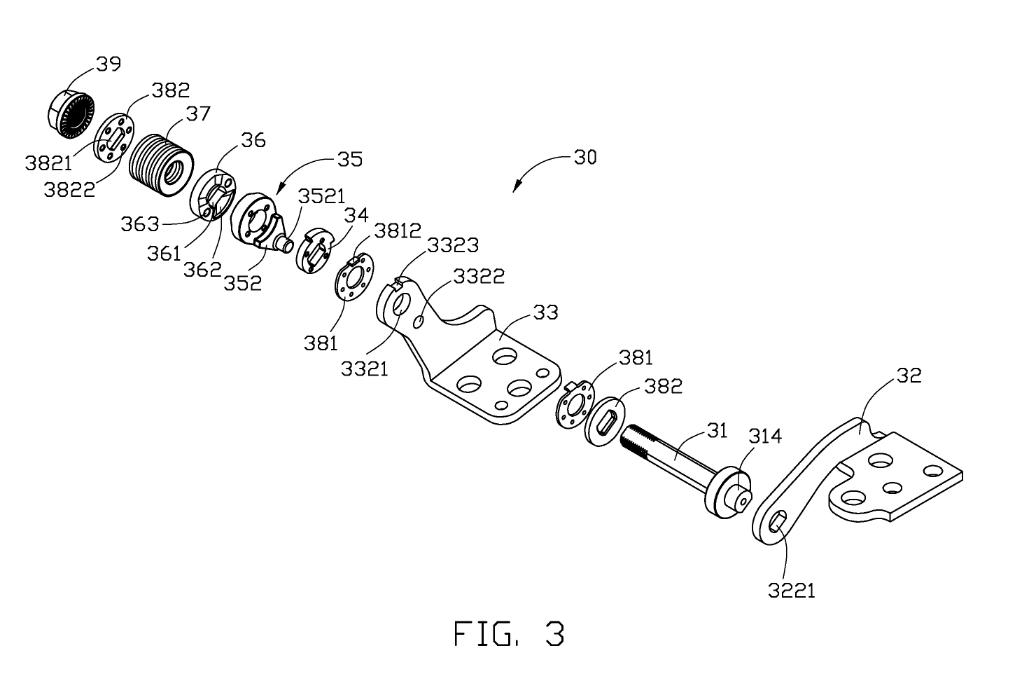

Referring to FIGS. 2 and 3, a cross-section of the rotatable shaft 31 perpendicular to an axis of the rotatable shaft 31 is double-D shaped. A flange 311 is formed on a proximal end of the rotatable shaft 31, and a threaded portion 312 is formed on a distal end of the shaft 31. A shaft head 314 is formed on the flange 311 along an extending direction of the rotatable shaft 31.

The rotatable stand 32 includes a flat plate 321. The flat plate 321 defines a plurality of fixing holes 3211. An arched positioning piece 322 extends substantially perpendicularly from a side of the flat plate 321. The positioning piece 322 defines a non-circular pivot hole 3221 corresponding to the shape of the shaft head 314 of the rotatable shaft 31.

The fixed stand 33 includes a fixing plate 331 and a supporting plate 332 extending substantially perpendicularly from a side of the fixing plate 331. The fixing plate 331 defines a plurality of fixing holes 3311. The supporting plate 332 defines a circular pivot hole 3321 in an end away from the fixing plate 331, and an assembling hole 3322 in a middle portion. The supporting plate 332 also defines an assembling cutout 3323 adjacent to the pivot hole 3321.

The restricting member 34 includes a circular main portion 341. A center of the main portion 341 defines a non-circular through hole 342 corresponding to the shape of the cross-section of the rotatable shaft 31. A first restricting portion 343 is formed at an edge of the main portion 341. In this embodiment, the first restricting portion 343 is an arched protrusion radially extending from an edge of the main body. The main portion 341 defines a plurality of oil grooves 344 therein.

The cam 35 includes a cylindrical assembling portion 351 and a second restricting portion 352 formed at one end of the assembling portion 351. In this embodiment, the second restricting portion 352 is substantially triangular-shaped, and a thickness of the restricting portion 352 is larger than a thickness of the assembling portion 351. A center of the assembling portion 351 defines a circular cam hole 3511. Two positioning protrusions 3512 are formed on a side surface of the assembling portion 351. The assembling portion 351 also defines a plurality of oil grooves 3513. A fixing pole 3521 extends from the second restricting portion 352.

The cam follower 36 is substantially cylindrical. A center of the cam follower 36 defines a non-circular through hole 361 corresponding to the shape of the distal end of the rotatable shaft 31. The cam follower 36 defines two positioning cutouts 362 in a side surface thereof. Each positioning cutout 362 is configured for receiving one corresponding positioning protrusion 3512 of the cam 35. The cam follower 36 also defines a plurality of oil grooves 363 in the side surface defining the positioning cutouts 362.

The restricting member 34, the cam 35, and the cam follower 36 are made of a metal via powder metallurgy technique.

A center of each friction member 381 defines a circular through hole 3811. A positioning piece 3812 is formed at the edge of each friction members 381. The positioning piece 3812 is configured for being received in the assembling cutout 3323 of the fixed stand 33. A plurality of oil grooves 3813 is defined in surfaces on opposite sides of each friction member 381. Each washer 382 defines a non-circular through hole 3811 corresponding to the cross-section of the rotatable shaft 31, and a plurality of oil grooves 3822 in the surfaces on opposite sides of each washer 382. The fastening member 39 is a nut configured to engage with the threaded portion 312 of the shaft 31 in this embodiment.

Referring to FIGS. 1 through 3, in assembling the hinge assembly 30, the threaded portion 312 of the rotatable shaft 31 extends through one washer 382, one friction member 381, the pivot hole 3321 of the fixed stand 33, the other friction member 381, the through hole 342 of the restricting member 34, the cam hole 3511 of the cam 35, the through hole 361 of the cam follower 36, a plurality of spring washers 37, the other washer 382, and engages with the fastening member 39. The shaft head 314 engages with the rotatable stand 32. Therefore, the rotatable stand 32, the restricting member 34, the cam follower 36 and the washers 382 are non-rotatably connected to the rotatable shaft 31. The first restricting portion 343 is positioned in the restricting groove 3512 of the cam 35. The fixing pole 3521 of the cam 35 is inserted into the assembling hole 3322 of the fixed stand 33. The positioning protrusions 3512 of the cam 35 engage with corresponding positioning cutouts 362. The positioning piece 3812 of each friction member 381 engages with the assembling cutout 3323 of the fixed stand 33. The fastening member 39 can be adjusted on the rotatable shaft 31, such that the spring washers 37 becomes elastically deformed and applies an elastic force effect on the cam follower 36.

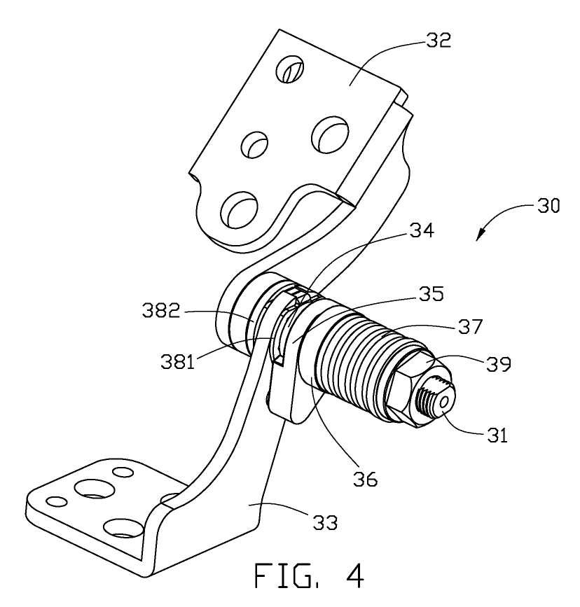

When the hinge assembly 30 is in an open position, the rotatable stand 32 is rotated on the rotatable shaft 31, for example, in a clockwise direction. The rotatable shaft 31 rotates together with the rotatable stand 32, and the restricting member 34 and the cam follower 36 rotate together with the rotatable shaft 31. When the restricting piece 343 of the restricting member 34 slides to a rear end of the restricting groove 3512 of the cam 35, the rotatable stand 32 has reached a clockwise rotatable limit and cannot rotate any further in the clockwise direction. In the clockwise rotatable limit, the rotatable stand 32 has rotated to a largest angle relative to the fixed stand 33 (as shown in FIG. 4). When rotating the hinge assembly 30 to the open position, the rotatable stand 32 can stop at any position (angle) between a closed position to the clockwise rotatable limit. When the hinge assembly 30 is operated to the closed position, the rotatable stand 32 is rotated around the rotatable shaft 31 in a counter clockwise direction. The rotatable shaft 31, the restricting member 34, and the cam follower 36 rotate together with the rotatable stand 32. The positioning protrusions 3512 of the cam 35 engages with the positioning cutouts 362, thereby fixing an angle between the rotatable stand 32 and the fixed stand 33.

The first restricting portion 343 of the restricting member 34 is slidable in the restricting groove 3512 of the cam 35, thus defining a rotating angle range between the rotatable stand 32 and the fixed stand 33. Since the cam 35 is made of a metal via powder metallurgy technique, the sidewall in the restricting groove 3512 has a high rigidity, and is less prone to wear and tear. Therefore, a largest rotating angle range between the rotatable stand 32 and the fixed stand 33 does not deviate, and the hinge assembly 30 has a long service life. In addition, the friction member 381 is positioned between the fixed stand 33 and the cam 35, thus preventing the fixed stand 33 from being scraped by the cam 35. Therefore, the fixed stand 33 can be made of a material with a low rigidity. In addition, the restricting member 34, the cam 35, the cam follower 36, the friction members 381, and the washers 382 defines oil grooves therein for reducing wear and tear, so a service life of the hinge assembly 30 is further prolonged.

It should be pointed out that, the positioning cutouts 362 of the cam follower 36 can be replaced by a plurality of positioning protrusions and the cam 35 should defines a plurality of positioning cutouts corresponding to the positioning protrusions. The restricting member 34, the cam 35, and the cam follower 36 can be made of other materials with high rigidity, such as metal stamping material. The cross-sections of the rotatable shaft 31 can be other shape, such as hexagon shaped. Accordingly, a corresponding restricting member 34, a corresponding cam follower 36 also define a hexagonal hole therein. In addition, the spring washers 37 can be replaced by other elastic members, such as coil springs. The rotatable shaft 31 and the rotatable stand 32 can be integrally formed.

It is believed that the present embodiments and their advantages will be understood from the foregoing description, and it will be apparent that various changes may be made thereto without departing from the spirit and scope of the or sacrificing all of its material advantages, the examples hereinbefore described merely being preferred or exemplary embodiments of the invention.

What is claimed is:

1. A hinge assembly, comprising:
a rotatable shaft;
a rotatable stand non-rotatably connected to the rotatable shaft;
a fixed stand rotatably connected to the rotatable shaft;
a cam rotatably connected to the rotatable shaft, and fixed to the fixed stand;
a restricting member non-rotatably connected to the rotatable shaft; and
a fastening member positioned at an end of the rotatable shaft;
wherein the restricting member has a first restricting portion; the cam has a second restricting portion; the first restricting portion and the second restricting portion cooperatively define a rotating angle range between the rotatable stand and the fixed stand.

2. The hinge assembly as claimed in claim 1, wherein the restricting member comprises a main body; the first restricting portion is an arched protrusion radially extending from a side surface of the main body; the cam comprises an assembling portion; the second restricting portion is formed at one end of the assembling portion; the restricting member resists the assembling portion.

3. The hinge assembly as claimed in claim 1, further comprising a cam follower; one of the cam and the cam follower defines a plurality of positioning cutouts, the other one of the cam and the cam follower forms a plurality of positioning protrusions configured for engaging with the positioning cutouts.

4. The hinge assembly as claimed in claim 3, further comprising a plurality of spring washers configured for generating an elastic force along the rotatable shaft.

5. The hinge assembly as claimed in claim 3, wherein at least one of the restricting member, the cam, and the cam follower defines a plurality of oil grooves.

6. The hinge assembly as claimed in claim 1, wherein a fixing pole is formed on the cam; the fixed stand defines an assembling hole; the fixing pole is fixedly received in the assembling hole of the fixed stand.

7. The hinge assembly as claimed in claim 1, further comprising two friction members sleeved on the rotatable shaft, and positioned at opposite sides of the fixed stand.

8. The hinge assembly as claimed in claim 6, wherein each friction member comprises a positioning piece; the fixed stand defines an assembling cutout in an edge thereof; the positioning piece is fixedly received in the assembling cutout of the fixed stand.

9. The hinge assembly as claimed in claim 1, wherein a threaded portion is formed at a first end of the rotatable shaft; the fastening member is a nut engaged with the threaded portion.

10. The hinge assembly as claimed in claim 9, wherein a flange is formed on a second end of the rotatable shaft opposite to the first end; the fixed stand, the cam, and the restricting member are positioned between the flange and the fastening member.

11. The hinge assembly as claimed in claim 1, wherein the cam and the restricting member are made of a metal via powder metallurgy technique.

12. A hinge assembly, comprising:
a rotatable shaft;
a rotatable stand and a fixed stand sleeved on the rotatable shaft such that the rotatable stand rotates together with the rotatable shaft;
a fixed stand rotatably connected to the rotatable shaft;
a cam rotatably connected to the rotatable shaft, and fixed to the fixed stand;
a cam follower, and
a restricting member non-rotatably on the rotatable shaft;
wherein an elastic member sleeved on the rotatable shaft for generating an elastic force along the rotatable shaft; the restricting member engages with the cam, thereby defining a rotating angle range between the rotatable stand and the fixed stand.

13. The hinge assembly as claimed in claim 12, wherein the elastic member comprises a plurality of spring washers.

14. The hinge assembly as claimed in claim 12, further comprising a cam follower; one of the cam and the cam follower defines a plurality of positioning cutouts, the other one of the cam and the cam follower forms a plurality of positioning protrusions configured for engaging with the positioning cutouts.

15. The hinge assembly as claimed in claim 14, wherein at least one of the restricting member, the cam, and the cam follower defines a plurality of oil grooves.

16. The hinge assembly as claimed in claim 12, wherein a fixing pole is formed on the cam; the fixed stand defines an assembling hole; the fixing pole is fixedly received in the assembling hole of the fixed stand.

17. The hinge assembly as claimed in claim 12, further comprising two friction members sleeved on the rotatable shaft, and positioned at opposite sides of the fixed stand.

18. The hinge assembly as claimed in claim 17, wherein each friction member comprises a positioning piece; the fixed stand defines an assembling cutout in an edge thereof; the positioning piece is fixedly received in the assembling cutout of the fixed stand.

19. The hinge assembly as claimed in claim 12, wherein a threaded portion is formed at a first end of the rotatable shaft; the fastening member is a nut engaged with the threaded portion.

20. The hinge assembly as claimed in claim 12, wherein the cam and the restricting member are made of a metal via powder metallurgy technique.
